(19) United States
(12) Patent Application Publication
(10) Pub. No.: US 2010/0119940 A1
(43) Pub. Date: May 13, 2010

(54) SECONDARY BATTERY

(76) Inventors: Satoshi Okano, Osaka (JP); Naoto Nishimura, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/615,500

(22) Filed: Nov. 10, 2009

(30) Foreign Application Priority Data
Nov. 11, 2008 (JP) 2008-288879

(51) Int. Cl. H01M 4/60

(52) U.S. Cl. 429/212

(57) ABSTRACT

A secondary battery having a positive electrode, negative electrode, and a separator, wherein at least one of the positive electrode and the negative electrode is formed of: a charge collector having resin as a core, and a metal layer; and an electrode active material on the metal layer, the metal layer of the charge collector is formed on one surface of the resin, and the charge collector is folded at least once.

This application is based on Japanese Patent Application No. 2008-28879 filed on Nov. 11, 2008, the contents of which are hereby incorporated by reference.

### BACKGROUND OF THE INVENTION

1. Field of the Invention

The present invention relates to a secondary battery that has a large capacity, and to a secondary battery that offers high safety at reduced cost.

2. Description of Related Art

Secondary batteries including lithium-ion secondary batteries have high capacity and high energy density, and are excellent in storage performance and in charge/discharge repetition characteristics; thus, they are widely used in consumer appliances. On the other hand, the secondary batteries use lithium metal and nonaqueous electrolyte solution, and thus require sufficient measures for safety.

For example, when, for some cause, short circuiting occurs between a positive electrode and a negative electrode of a secondary battery, in a case where the battery has a large capacity and high energy density, excessively large short-circuiting current passes and, due to the internal resistance, Joule's heat generates, raising the temperature of the battery. Thus, in secondary batteries using nonaqueous electrolyte solution, including lithium-ion secondary batteries, there is provided a function for preventing a battery from falling into an abnormal state.

Of a large number of proposals made so far for an abnormal-state prevention function, in JP-A-11-102711, a lithium-ion secondary battery is reported in which, as in a structure shown in FIG. 5, an electrode portion 101 has active material layers 104 of a positive-electrode and a negative-electrode are formed on a charge collector that is formed of a low-melting (130° C. to 170° C.) resin film 102 and metal layers 103a formed on both surfaces of the resin film 102.

In such batteries having a charge collector that includes a resin film 102, when short circuiting occurs due to, for example, foreign matter entering between the positive electrode and the negative electrode, and abnormal heating occurs, the low-melting resin film 102 fuses apart and the metal layers formed on it break also, interrupting the current. As a result, rising of the temperature inside the battery and hence ignition is prevented.

On the other hand, in JP-A-2006-147300, as an inexpensive structure of a battery, there is proposed a structure folded like a folding screen as shown in FIG. 6. In this structure, with a positive electrode 201, a separator 203, and a negative electrode 202 all formed into a band shape, and with an active material layer 201a of the cathode 201 applied on one surface alone of a metal-strip charge collector layer 201b, individual components are laid on one another, and are bent, to achieve excellent productivity and equipment cost reduction.

According to JP-A-11-102711 described above, the battery including the charge collector has metal layers 103 formed at the front and back of the resin film 102. Methods of forming the metal layers include one in which metal strips are adhered at the front and back of the resin film with adhesive layers, and one in which metal is applied to the resin film by electroless plating to form the metal layers; from the viewpoint of easy processing, vapor deposition is practical.

When forming a metal film by vapor deposition, however, in order to prevent the resin film from being thermally degraded due to the process temperature, the surface opposite to a processing surface of the resin film needs to be cooled. Specifically, forming metal layers at the front and back simultaneously is difficult, and thus, after the front surface is formed, the resin film needs to be reset for processing the rear surface. In particular, the larger the size of an electrode and the more long-dimension processing is needed, the larger an apparatus itself; thus, it takes time to vacuum and to set the resin film, and thus the processing cost is increased, which is a problem.

Moreover, according to JP-A-2006-147300 described above, in the structure folded like a folding screen, a charge collector terminal 204a of the positive electrode 201 and a charge collector terminal 204b of the negative electrode 22 are located at one places, respectively. Thus, when this conventional technology is applied to a resin film onto which metal is vapor-deposited, since a metal vapor-deposited film, compared with a metal strip, is thinner and has a higher resistance in general, collecting current at one place makes it impossible to cope with large-capacity batteries, which is a problem.

The present invention is devised to solve the problems described above, and an object of the invention is to provide a secondary battery in which, when short circuiting occurs even when the battery is large and has, for example, a battery capacity of several Ah or more, thermal runaway can be prevented inexpensively and surely.

### SUMMARY OF THE INVENTION

According to the present invention, a secondary battery comprises a positive electrode, a negative electrode, and a separator, wherein at least one of the positive electrode and the negative electrode is formed of: a charge collector that has resin as a core, and a metal layer; and an electrode active material on the metal layer, the metal layer of the charge collector is formed on one surface of the resin, and the charge collector is folded at least one time.

In the secondary battery according to the invention, it is preferable that, as the charge collector having resin as a core, a plurality of them be laid together alternately with the other electrode, electrode terminals be formed at an end of each of the charge collectors, and electrode terminals be electrically connected in parallel.

According to the invention, a secondary battery comprises a positive electrode, a negative electrode, and a separator, wherein at least one of the positive electrode and the negative electrode is formed of: a charge collector having resin as a core, and a metal layer; and an electrode active material on the metal layer, the charge collector is folded like a folding screen, and a plurality of electrode terminals are formed at a curved part of the folded charge collector, on one side thereof.

In the secondary battery according to the invention, it is preferable that the metal layer be formed on the resin by vapor deposition.

According to the invention, it is preferable that the secondary battery have a capacity of 4 Ah or more.

According to the secondary battery structured as described above, it is possible to form a secondary battery with an inexpensive structure, and to prevent thermal runaway even when the battery has a large capacity.

### BRIEF DESCRIPTION OF THE DRAWINGS

FIG. 1 is a sectional view schematically showing one embodiment of a secondary battery according to the present invention.

FIG. 2A is a sectional view schematically showing a laid member according to one embodiment of the invention that has a metal layer and an active material formed on a resin film.

FIG. 2B is a sectional view schematically showing the laid member in FIG. 2A in a state where it is folded once.

FIG. 3 is a sectional view schematically showing the secondary battery according to the invention in which a groove is formed in a resin film.

FIG. 4 is a sectional view schematically illustrating another embodiment of the secondary battery according to the invention.

FIG. 5 is a sectional view schematically illustrating an example of a conventional secondary battery.

FIG. 6 is a sectional view schematically illustrating another example of a conventional secondary battery.

### DETAILED DESCRIPTION OF PREFERRED EMBODIMENTS

Embodiments of the present invention will be described below with reference to the accompanying drawings. Among the different drawings referred to in the following description, the same or corresponding parts are identified by the same reference signs, and no description of them will be repeated. In the drawings, the dimensional relationship of length, size, width, and the like is changed as required for the sake of clarity and simplicity of the drawings, and actual dimensions are not shown.

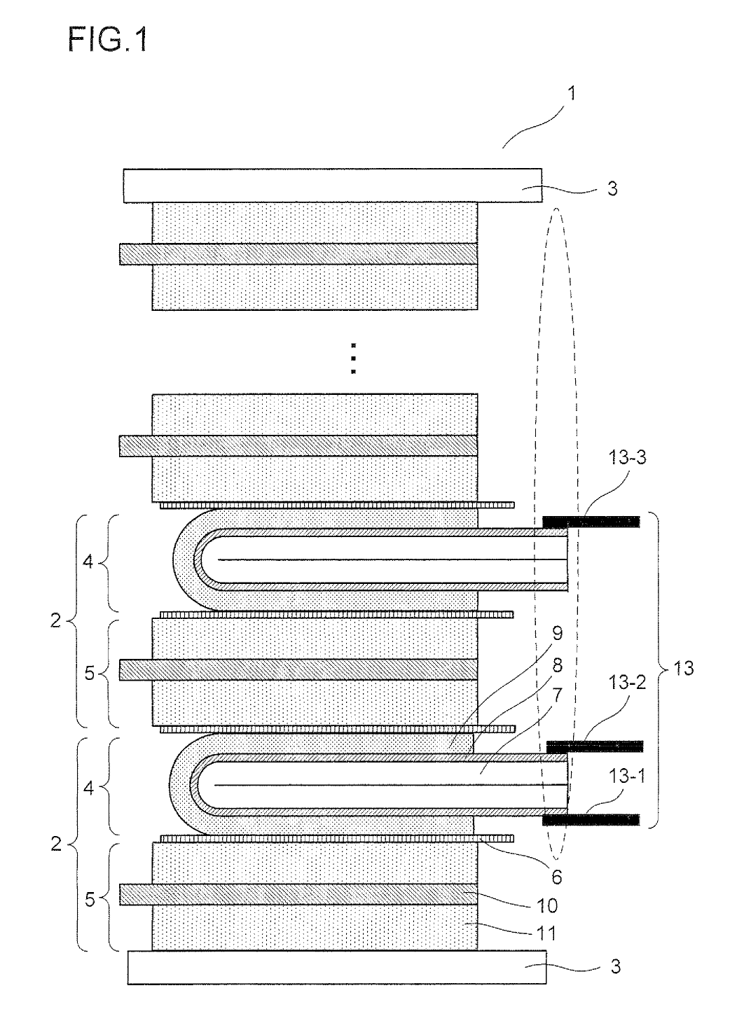

FIG. 1 is a diagram schematically showing one embodiment of a secondary battery according to the present invention. The secondary battery 1 according to this embodiment is provided with an electrode portion 2, an exterior can 3, and nonaqueous electrolyte solution (unillustrated). The secondary battery 1 has the electrode portion 2 and the nonaqueous electrolyte solution sealed in the exterior can 3. In this embodiment, the electrode portion 2 is provided with a positive electrode 4, a negative electrode 5, and laid between them, a separator 6. At least one of the positive electrode 4 and the negative electrode 5 is formed of a resin film 7 as a core, a metal layer 8 (charge collector), and an electrode material 9 (an active material). In FIG. 1, the embodiment in which the resin film 7 is provided in the positive electrode 4 is shown, however, the resin film 7 may be provided in the negative electrode 5 or in both electrodes.

In the secondary battery, positive terminals (13-1, 2, 3, made of a material typified by aluminum are formed at an end of a metal layer 8, namely a charge collector, by spot welding, ultrasonic welding, or the like, and these positive terminals are electrically connected in parallel. With this structure, needless to say, it is possible to extract electricity out of the secondary battery and to charge it.

Likewise in the negative electrode, negative terminals (unillustrated) made of a material—typically nickel—is formed, and these negative terminals are electrically connected in parallel, so that, needless to say, it is possible to extract electricity out of the secondary battery and to charge it.

As described above, by using the charge collector having the resin film 7 as a core, when internal short circuiting occurs in the battery and abnormal heating occurs, the resin film fuses apart in a part that is close to where the short circuiting has occurred, and the metal layer formed on the resin film breaks, eliminating the short circuiting.

Hereinafter, a description is given of components of the secondary battery according to this embodiment.

<Resin Film>

As a material of the resin film 7, a plastic material can be used that thermally deforms when temperature rises. Examples include resin films and the like formed of polyethylene (PE), polyolefin resin such as polypropylene (PP), polystyrene (PS), or the like, of which all have a thermal distortion temperature of 150° C. or below.

For the fusing-apart function of the resin according to this embodiment, the thermal distortion temperature of the resin film is an important parameter. When the thermal distortion temperature is as extremely high as 200° C. or above, a chemical reaction is caused between components inside the battery, leading to a thermal runaway.

When the thermal distortion temperature is within a low temperature range approximately from 60° C. to 100° C., the function as a battery is lost when the normal operation range is slightly exceeded, and thus the performance is significantly degraded.

The thickness of the resin film 7 is preferably 10 to 20 μm. When the thickness is large, though handling is improved, the final form as a secondary battery is thick. On the other hand, when the thickness is small, the resin film stretches extremely, or breaks, due to the load during processing, which is a problem.

The resin film may be one that is manufactured by any method including uniaxial stretching, biaxial stretching, no stretching, and the like.

<Laid Member>

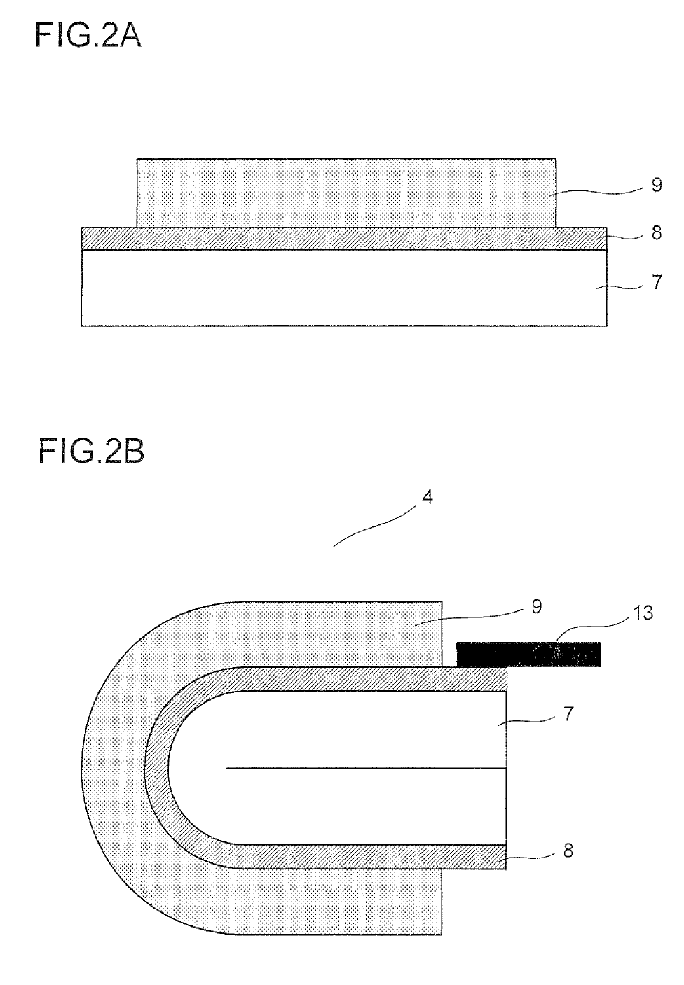

FIG. 2A is a diagram showing the structure of a laid member according to this embodiment in which the above-described resin film 7 is used. The embodiment described below deals with a case in which the invention is applied to the positive electrode.

A positive-electrode metal layer 8 is formed on one surface of the resin film 7 by vacuum deposition, and on the positive-electrode metal layer 8, a positive-electrode active material 9 is formed by coating, and then drying is performed.

Next, pressing is performed to enhance adhesion between the positive-electrode metal layer 8 and the positive-electrode active material 9, and to improve bonding among different parts of the positive-electrode active material 9, so that a structure shown in FIG. 2A is obtained in which the components are laid together.

Next, as shown in FIG. 2B, a laid member as a whole is bent at a center part. As a bending method used then, a thin plate is pressed against the laid member at a desired bending position to bend along it, which is easy. Thus, the laid member is formed to be curved, and thereby the metal layer 8 and the positive-electrode active material 9 are formed on both surfaces of the resin film 7.

The thickness of the metal layer 8 varies depending on the type of metal of which it is formed, and is preferably within the range of 0.5 to 5 μm. If the thickness is smaller than 0.5 μm, the strength of the metal layer itself may be lowered, and in addition the internal resistance of the battery may be increased. On the other hand, if the thickness is larger than 5 μm, an unnecessary volume may be generated in the battery, and the cost of forming the metal layer may be increased. When the battery is for power storage use, charge/discharge performance at a high rate is not so required as with lithium-ion secondary batteries for portable appliances or for electric vehicles. Thus, the thickness of the metal layer can be 1 to 2 μm. When the battery is intended for use in portable appliances or in electric vehicles, the thickness of the metal layer can be 2 to 20 μm.

In a case where this structure is used on the negative electrode side, likewise, a metal layer is formed on a resin film, then, on the metal layer, an active material is formed by coating, and then drying and pressing are performed, so as to obtain this structure.

An example of the material of the metal layer 8 is a layer of metal selected from copper, nickel, ion, aluminum, zinc, gold, platinum and the like. Among them, for the positive-electrode charge collector, aluminum is preferable with a viewpoint of high resistance to oxidization; for the negative-electrode charge collector, copper is preferable with a viewpoint of being less likely to alloy with lithium ion.

<Positive Electrode>

A positive electrode can be fabricated by applying a paste on the charge collector, then performing drying and pressing, the paste containing a positive-electrode active material, a conductive agent, a binder, and an organic solvent.

An example of the positive-electrode active material is an oxide containing lithium. Specifically, there are used for example, LiCoO₂, LiNiO₂, LiFeO₂, LiMnO₂, LiMn₂O₄, and chemical compounds in which the transition metal in the oxides just mentioned is substituted in part by another metal element. Among them, one that allows 80% or more of the lithium amount held by the positive electrode to be used for cell reaction, under normal usage, is preferably used as a positive-electrode active material; this makes it possible to enhance the safety of the battery against accidents such as overcharging. Examples of such positive-electrode active material include chemical compounds having a spinel structure such as LiMn₂O₄, chemical compounds having an olivine structure typically LiMPO₄ (M represents at least one or more elements selected from the group of Co, Ni, Mn, and Fe), and the like. Among them, a positive-electrode active material containing Mn and/or Fe is preferable from the viewpoint of cost. Furthermore, from the view point of safety and the charging voltage, LiFePO₄ is preferable. In LiFePO₄, all the oxygen is bonded with phosphorus by strong covalent bond, and discharge of oxygen due to a rise in temperature is less likely to occur, which enhances safety. Since LiFePO₄ contains phosphorus, anti-inflammatory action can be expected.

As the conductive agent, a carbonaceous material, for example, acetylene black, Ketjenblack, or the like can be added, or a publicly known additive or the like can be added.

As the binder, for example, polyvinylidene fluoride, polyvinylpyridine, polytetrafluoroethylene, or the like can be used.

As the organic solvent, for example, N-methyl-2-pyrrolidon (NMP), N,N-dimethylformamide (DMF), or the like can be used.

As a charge collector, in which a structure having a resin film as a core is applied to a negative electrode and no resin film is used in a positive electrode, one that is widely known, for example, a conductive metal strip or a thin plate of aluminum or the like can be used. Here, the thickness may be about 20 μm generally.

<Negative Electrode>

A negative electrode can be fabricated by applying a paste on the charge collector, and performing drying and pressing, the paste containing a negative-electrode active material, a conductive material, a binder, an organic solvent, and pure water.

As the negative-electrode active material, there may be used natural graphite; artificial graphite having a particulate shape (such as scale-shape, block-shape, fibrous, whisker-shape, spherical, granular, etc); high crystallinity graphite, of which typical examples include, among others, graphitization product such as mesocarbon microbead, mesophase pitch powder, and isotropic pitch powder; or non-graphitizable carbon such as resin-fired carbon and the like. Furthermore, these may be used by mixing them together. Moreover, it is also possible to use a negative-electrode active material of alloy base having a large capacity, such as tin oxide, a negative-electrode active material of silicon base, and the like. Among them, a graphitic carbon material has a charge/discharge reaction potential of which the flatness is high, and this potential is close to the dissolution/deposition potential of metal lithium, and thus high energy densification can be achieved, which is preferable. Furthermore, a graphite powder material having amorphous carbon adhered on its surface suppresses the decomposition reaction of nonaqueous electrolyte solution accompanied by charging/discharging, and reduces gas occurring in the battery, which is preferable.

The average particle diameter of the graphitic carbon material, as a negative-electrode active material, is preferably 2 to 50 μm and further preferably, 5 to 30 μm. If the average particle diameter is smaller than 2 μm, the negative-electrode carbon material may pass through a pore in a separator, and the negative-electrode carbon material so passed through may cause short circuiting in the battery. On the other hand, if the average particle diameter is larger than 50 μm, formation of the negative electrode may be difficult. The specific surface of the negative-electrode carbon material is preferably 1 to 100 m²/g, and further preferably, 2 to 20 m²/g. If the specific surface is smaller than 1 m²/g, parts where lithium insertion/extraction reaction occurs is lessened, possibly lowering the large-current-discharging performance of the battery. On the other hand, if the specific surface is larger than 100 m²/g, area on the surface of the negative-electrode active material increases where a decomposition reaction of nonaqueous electrolyte solution occurs, and occurrence of gas etc. may be caused in the battery. Here, in the invention, the values of the average particle diameter and the specific area are measured by use of an automatic gas/vapor absorption measurement apparatus BEL SORP 18 manufactured by BEL Japan Inc.

As the conductive agent, for example, a carbonaceous material such as acetylene black, and Ketjenblack can be added, or a publicly known additive or the like can be added.

As the binder, for example, polyvinylidene fluoride, polyvinylpyridine, polytetrafluoroethylene, styrene-butadiene rubber, or the like can be used.

As the organic solvent, N-methyl-2-pyrrolidon (NMP), N,N-dimethylformamide (DMF), or the like can be used.

As a charge collector, in which a structure having a resin film as a core is applied to a positive electrode and no resin film is used in a negative electrode, one which is widely known, for example, a metal strip of copper, nickel, or the like can be used as necessary. Here, the thickness may be about 12 μm generally.

<Separator>

A separator that achieves electrical insulation by being interposed between the positive electrode and the negative electrode, and that enables ionic conduction between the positive and the negative electrode through interposed nonaqueous electrolyte solution is formed of, for example, a porous film. Considering the solvent resistance and the oxidation-reduction resistance, as the separator, a porous film that is formed, for example, of polyolefin resin such as polyethylene or polypropylene is suitable. In addition, so that a pore of the separator closes to interrupt the ionic conduction when heat is generated in the secondary battery due to an internal short circuiting in the electrode portion, it is preferable that the separator has a melting point of 200° C. or below but higher than that of the resin film of the charge collector.

The thickness of the separator is not limited so long as it is thick enough to hold the required amount of electrolytic solution and to prevent short circuiting between the positive and the negative electrode. The thickness may be, for example, about 0.01 to 1 mm and, preferably, about 0.02 to 0.05 mm. In addition, the material forming the separator preferably has an air permeability of 1 to 500 second/cm³, so that strength enough to prevent short circuiting inside the battery can be achieved while the internal resistance of battery is maintained low.

<Nonaqueous Electrolyte Solution>

In the secondary battery according to this embodiment, an example of a nonaqueous electrolyte solution is a solution having electrolyte salt dissolved in an organic solvent.

As the electrolyte salt, when using a lithium-ion secondary battery, for example, one having lithium as a cationic component is preferable; as an example, there is used lithium salt that has, as an anionic component, organic acid including lithium borofluoride, lithium hexafluorophosphate, lithium perchlorate, fluorine-substituted organic sulfonic acid, and the like.

As the organic solvent, any one can be used so long as it dissolves the electrolyte salt described above; examples include cyclic carbon acid esters, such as ethylene carbonate, propylene carbonate, and butylene carbonate; cyclic esters such as γ-butyrolactone; ethers, such as tetrahydrofuran and dimethoxyethane; and chain carbon acid esters, such as dimethyl carbonate, diethyl carbonate, and ethyl methyl carbonate. These organic solvents can be used singly or as a mixture of two or more.

<Exterior Can>

As an exterior can used in the invention, it is preferable that a metal can, namely a material having ion plated with nickel, be used. The reason for this is that the strength as the exterior can can be achieved inexpensively. Examples of other materials include cans formed of stainless steel, aluminum, or the like. The shape of the exterior can may be any one of slim flat tube type, cylindrical type, square tube type, and the like; in a case of a large lithium secondary battery, it is likely to be used as a battery pack, and thus a slim flat tube type or a square tube type is preferable.

In the invention, all the materials described above are simply examples, with no limitation thereto intended; any material can be used so long as it is known to be used in secondary batteries.

Hereinafter, the invention will be described in detail by way of practical examples thereof, however, these are not meant to limit in any way the manner in which the invention can be carried out.

### Practical Example 1

Hereinafter, practical example 1 of a secondary battery according to the present invention will be described with reference to FIG. 2. In this practical example, first, an electrode portion having a structure shown in FIG. 2A was fabricated. In this practical example, a description will be given on an electrode having a resin film as a core being used as a positive electrode, and a negative electrode active material being applied on a metal strip as a negative electrode.

As a resin film 7, a biaxial stretching-type polypropylene film (TORAY Industries, Inc.: Film YK57), with thickness 15 μm, width 80 mm, and length 350 mm, was used. On the resin film 7, aluminum (1.5 μm thick), which is a metal layer 8 for a positive-electrode charge collector, was formed by vacuum vapor deposition. On top of this, a positive-electrode active material layer 9 (active material:acetylene black:PVDF=90:5:5 (ratio by weight)) having an olivine structure LiFePO₄ as a positive-electrode active material was applied such that part of a positive-electrode metal layer was exposed. This was then dried at 80° C. and pressed such that the positive-electrode active material layer had a thickness of 80 μm at each side. As PVDF (poly (vinylidene fluoride)), KF polymer (registered mark) manufactured by KUREHA Corporation was used, and, as acetylene black, DENKA BLACK (registered mark) manufactured by DENKI KAGAKU KOGYO KABUSHIKI KAISHA was used.

The electrode obtained in such a way was bent at a central part to obtain a symmetrical structure with respect to the bent surface as shown in FIG. 2B. A part of the positive-electrode metal layer 8 so obtained, where no positive-electrode active material layer 9 was formed, was fitted by ultrasonic welding with an aluminum positive terminal 13 for extracting current out to an external circuit.

A negative electrode 5 shown in FIG. 1 was formed by: forming a negative-electrode active material layer 11 (active material:SBR=95:5 (ratio by weight)) having amorphous carbon-adhered black graphite (OMAC (registered mark) manufactured by Osaka Gas Chemicals Co., Ltd., with the average particle diameter 10 μm and the specific surface 2 m²/g) as a negative-electrode active material on a negative-electrode metal layer 10 formed of rolled copper strip of 12 μm thick; drying at 80° C.; and pressing such that the negative-electrode active layer had a thickness of 70 μm at each side. As SBR (styrene-butadiene rubber), BM-400B manufactured by ZEON Co., Ltd. was used.

As a separator 6, a microporous film (with the thermal distortion temperature 150° C. or above, and the thermal contraction ratio 0.4%) having a thickness of 25 μm and an outer dimension larger than the positive electrode 4 by 10 mm was used.

With respect to the components as described above, first, the negative electrode 5, the separator 6, the positive electrode 4, the separator 6, . . . were laid on one another in this order from the bottom until the number of layers required for a predetermined capacity is achieved, and then, the laid member was fixed with a Kapton (registered mark) tape such that no deviation occurs. In this practical example, to obtain a secondary battery having a capacity of 4 Ah, 10 layers of negative electrode and 9 layers of positive electrode were laid on one another.

Here, the separator had only to be electrically insulating between the positive electrode and the negative electrode, and with a view to facilitating laying, a positive electrode 4 was thermally sealed by separators 6 that were in an up/down positional relationship with the positive electrode 4, so as to form a single piece.

After laying, the positive electrodes (13-1, 2, 3, . . . ) were all collectively connected by ultrasonic welding. Specifically, by welding the entire part encircled by a broken line in FIG. 1, positive electrodes located at above and below were electrically connected in parallel, and since the region in which current is collected by a single positive terminal 13 is reduced and the resistance is decreased, it is possible to reduce a loss of electricity.

In addition, the negative electrode 5 had a part of the negative-electrode metal layer 10, where no negative-electrode active material layer 11 was formed, fitted by ultrasonic welding with a nickel negative-electrode lead (unillustrated) for extracting current out.

The laid member obtained as described above was put into a can formed of a material having ion plated with nickel, and then 25 ml of an electrolytic solution having LiPF₆ dissolved, so as to be 1 mol/L, in a mixed solvent of EC and DMC (EC:DMC=30:70 (ratio by volume)) was injected. Then, with the same material, namely ion plated with nickel, a lid was formed, and the outer edge of the lid was welded, by laser, to be sealed.

Through the steps described above, the lithium ion secondary battery shown in FIG. 1 was obtained. In FIG. 1, a sealed part of the can is omitted. The size of the battery was 80 mm in width, 180 mm in length, and 5 mm in thickness, and the capacity of the battery was 4 Ah.

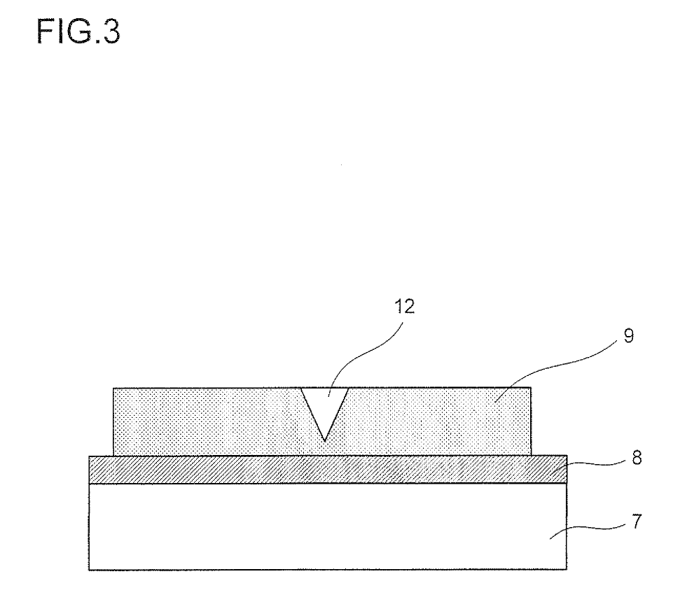

In the charge collector, as shown in FIG. 3, forming a groove 12 in an electrode material facilitates bending. Thus, by forming a groove in a part located on the outer side of the side to be bent, the electrode material is stretched during bending and no cracking or chipping occurs and hence no scrap is produced, which is preferable. The groove 12 may be formed by a slitter. The shape of the groove is preferably triangle, which has an effect of facilitating bending. In this practical example, a triangle groove of 50 μm depth was formed to an electrode material of 80 μm, and the effect was observed. Other methods include forming of a slit.

As another form of this shape, part of the electrode material to be bent may be uncoated in the first place so that no electrode material is formed there. In this structure also, it is possible to obtain a similar effect to that in the case when a slit is formed.

### Practical Example 2

Compared with the secondary battery in the practical example 1, that in a practical example 2 according to the embodiment differs in that an olivine structure LiMn₂O₄ was used as the positive-electrode active material. In other respects, the structure was similar to that in the practical example 1.

### Comparative Example 1

Compared with the secondary battery in the practical example 1, that in a comparative example 1 according to the invention differs in that an olivine structure LiCoO₂ was used as the positive-electrode active material, and artificial graphite as the negative-electrode active material. In other respects, the structure is similar to that in the practical example 1.

### Comparative Example 2

Compared with the secondary battery in the practical example 1, that in a comparative example 2 according to the invention differs in that, as the positive electrode, one having a positive-electrode active material layer formed on one surface of an aluminum strip and being folded once was used. Specifically, no resin film was used in the positive electrode. As the positive-electrode active material, an olivine structure LiMn₂O₄ was used. In other respects, the structure was similar to that in the practical example 1.

### Practical Example 3

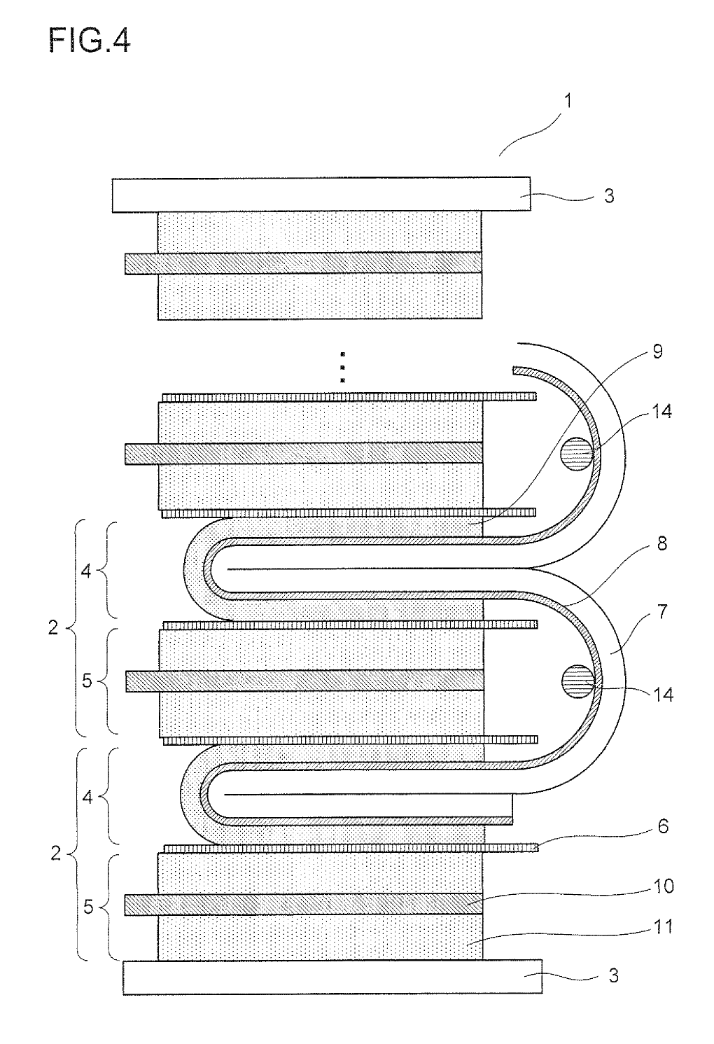

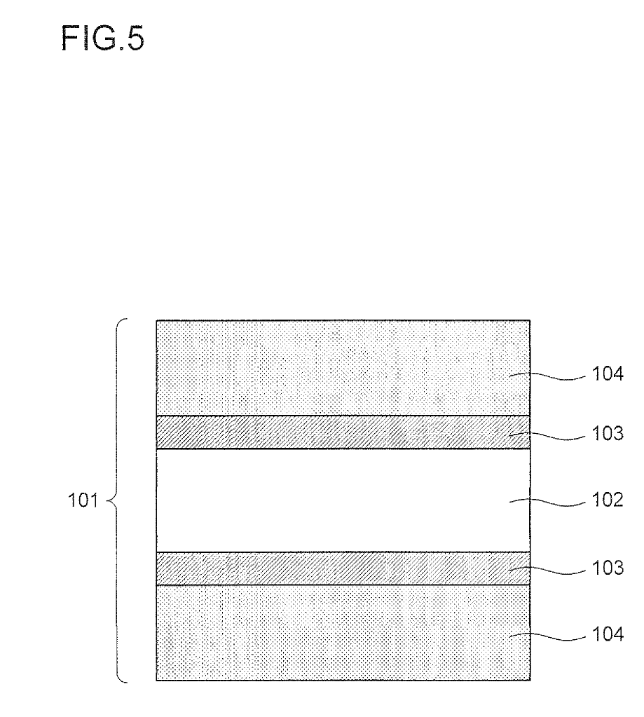

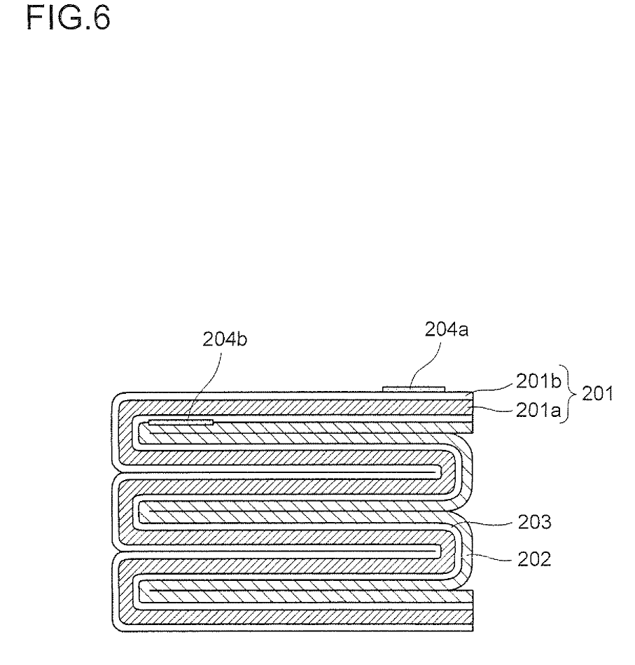

Next, a practical example 3 of a secondary battery according to the invention will be described with reference to FIGS. 3 and 4. No explanation will be given of contents similar to those in the practical example 1. In the practical example 1, the charge collector having resin as a core was laid one after another, whereas in the practical example 2, the charge collector (in the practical example 3, a positive electrode) having resin as a core was folded like a folding screen.

First, a positive electrode 7 having a band shape was prepared. Here, a shape required for forming one secondary battery was 80 mm in width and 3300 mm in length. Since it is very long, it is maintained in a rolled state upon handling.

As the negative electrode, one having the same specification as in the practical example 1 was used.

With respect to the components described above, a secondary battery was obtained by the following procedure.

(a) The separator 6 was laid on the negative electrode 5.

(b) The positive electrode 4 was formed with the resin film 7 of the positive electrode being folded such that the resin film 7 makes direct contact with its folded-back part.

(c) On the folded positive electrode 4, a separator 6, a negative electrode 5, and a separator 6 were laid on.

(d) From the top of the separator 6 just mentioned, the rest of the positive electrode was laid over such that a positive terminal 14 formed out of an aluminum bar was caught in, and then, as in step (b), the resin film 7 of the positive electrode was folded such that the resin film 7 makes direct contact with its folded-back part.

Then, to obtain a predetermined capacity, the steps (c) and (d) described above were repeated for a number of times. After laying was completed, by connecting by ultrasonic welding a plurality of positive terminals 14, which are formed at a curved part of the positive electrode 4 folded like a folding screen, on one side thereof, each regions were electrically connected in parallel; furthermore, a terminal (unillustrated) was connected for extracting electricity out.

The laid member obtained as described above was put into a can formed of a material having ion plated with nickel, and then 25 ml of an electrolytic solution having LiPF₆ dissolved, so as to be 1 mol/L, in a mixed solvent of EC and DMC (EC:DMC=30:70 (ratio by volume)) was injected. Then, with the same material, namely ion plated with nickel, a lid was formed, and the outer edge of the lid was welded by laser, to be sealed.

Although the practical example 3 dealt with a case in which the separator was laid over as a separate component, it is also possible to form the separator into a band-shape along with the band-shaped positive electrode and, with the positive electrode and the separator being laid together, fold them like a folding screen.

### Comparative Example 3

Compared with the secondary battery in the practical example 3, that in a comparative example 3 according to the invention differs in that, as the positive electrode, one having a positive-electrode active material layer formed on one surface of an aluminum strip and being folded like a folding screen was used. Specifically, no resin film was used in the positive electrode. As the positive-electrode active material, an olivine structure LiMn₂O₄ was used. In other respects, the structure was similar to that in the practical example 3.

### Practical Example 4

Compared with the secondary battery in the practical example 1, that in a practical example 4 according to the invention differs in that an olivine structure LiCoO₂ was used as the positive-electrode active material, and artificial graphite as the negative-electrode active material. In other respects, the structure was similar to that in the practical example 1.

### Comparative Example 4

Compared with the secondary battery in the practical example 4, that in a comparative example 4 according to the invention differs in that, as the positive electrode, one having a positive-electrode active material layer formed on one surface of an aluminum strip and being folded once was used. Specifically, no resin film was used in the positive electrode. In other respects, the structure was similar to that in the practical example 4.

### Practical Example 5

Compared with the secondary battery in the practical example 1, that in a practical example 5 according to the invention differs in that an olivine structure LiMn₂O₄ was used as the positive-electrode active material, and artificial graphite as the negative-electrode active material. In other respects, the structure is similar to that in the practical example 1.

### Comparative Example 5

Compared with the secondary battery in the practical example 5, that in a comparative example 5 according to the invention differs in that, as the positive electrode, one having a positive-electrode active material layer formed on one surface of an aluminum strip and being folded once was used. Specifically, no resin film was used in the positive electrode. In other respects, the structure was similar to that in the practical example 5.

(Battery Evaluation)

To a secondary battery fabricated with a design of 4Ah capacity according to the structure in the above-described practical example 1, charging was performed up to a battery voltage of 3.6 V at a constant current of 400 mA (corresponding to 0.1 C), then charging was performed for three hours at a constant voltage of 3.6 V, and then discharge was performed down to a battery voltage of 2.5 V at a constant current of 800 mA (corresponding to 0.2 C). The capacity of the battery then was 3.95 Ah, and thus a secondary battery according to the design value was obtained.

The secondary batteries of the practical examples 1 to 5 and the comparative examples 1 to 5 were fully charged, and then a nailing test was performed. In the nailing test, a nail with a nail diameter φ of 3 mm was inserted through a battery under the condition of the nailing speed at 1 mm/s. The results were as shown in Table 1. Note that criteria in the reliability result in the table, smoke is indicated by “▴”, and ignition is indicated by “x”.

TABLE 1

| | | | | | | | Reliability |
|---|---|---|---|---|---|---|---|
| | Positive | | Negative | | | | result |
| | electrode | | electrode | | | | (evaluation |
| | Resin | Electrode | Resin | Electrode | Capacity | Resin film | with 5 |
| | film | material | film | material | (Ah) | structure | samples) |
| Practical | with | LiFePO₄ | without | OMAC | 4 | laid | — |
| Example 1 | | | | (amorphous | | | |
| | | | | carbon | | | |
| | | | | adhered) | | | |
| Practical | with | LiFePO₄ | without | OMAC | 18 | laid | — |
| Example 2 | | | | (amorphous | | | |
| | | | | carbon | | | |
| | | | | adhered) | | | |
| Comparative | with | LiMn₂O₄ | without | OMAC | 4 | laid | ▴ |
| Example 1 | | | | (amorphous | | | (Smoking in |
| | | | | carbon | | | one sample) |
| | | | | adhered) | | | |
| Comparative | without | LiMn₂O₄ | without | OMAC | 4 | laid | x |
| Example 2 | | | | (amorphous | | | (Ignition in |
| | | | | carbon | | | all samples) |
| | | | | adhered) | | | |
| Practical | with | LiFePO₄ | without | OMAC | 4 | Folded | — |
| Example 3 | | | | (amorphous | | like a | |
| | | | | carbon | | folding | |
| | | | | adhered) | | screen | |
| Comparative | without | LiMn₂O₄ | without | OMAC | 4 | Folded | x |
| Example 3 | | | | (amorphous | | like a | (Ignition in |
| | | | | carbon | | folding | all samples) |
| | | | | adhered) | | screen | |
| Practical | with | LiCoO₂ | without | Aritificial | 4 | laid | ▴ |
| Example 4 | | | | graphite | | | (Smoking in |
| | | | | | | | two |
| | | | | | | | samples) |
| Comparative | without | LiCoO₂ | without | Aritificial | 4 | laid | x |
| Example 4 | | | | graphite | | | (Ignition in |
| | | | | | | | all samples) |
| Practical | with | LiMn₂O₄ | without | Aritificial | 4 | laid | ▴ |
| Example 5 | | | | graphite | | | (Smoking in |
| | | | | | | | three |
| | | | | | | | samples) |
| Comparative | without | LiMn₂O₄ | without | Aritificial | 4 | laid | x |
| Example 5 | | | | graphite | | | (Ignition in |
| | | | | | | | all samples) |

According to the results, the secondary battery in the practical example 1 had its surface temperature risen up to 70° C. immediately after the nailing test, however, the temperature then decreased gradually down to room temperature. No smoking nor ignition was observed. The secondary battery in the practical example 2 that had its capacity increased also had its surface temperature risen but no smoking nor ignition occurred.

By contrast, with the secondary battery in the comparative example 1, smoking was observed in one sample, and with the secondary battery in the comparative example 2, ignition occurred in all samples.

According to the results described above, using a resin film according to the invention as a core made it possible, even if short circuiting occurs between the positive and the negative electrode, to prevent thermal runaway and hence ignition, and to enhance safety.

Moreover, by the nailing test described above, the following in particular was made clear.

In the practical example 1 and the comparative example 2, a resin film was used as a charge collector, and thereby no ignition occurred and safety could be enhanced, and furthermore, LiFePO₄ was used as an electrode material of the positive electrode, and thereby, compared with LiMn₂O₄, no smoking occurred, which is even safer.

In the practical example 3 and the comparative example 3, by using a resin film also in an electrode structure folded like a folding screen, safety can be enhanced.

The practical examples 4 and 5 and comparative examples 4 and 5 are examples in which with/without a resin film was changed, the positive-electrode material was changed to LiCoO₂ or LiMn₂O₄, and artificial graphite was used as an electrode material of the negative electrode; in those examples, no ignition occurred in the cases when a resin film was used, enhancing safety.

Accordingly, with respect to the electrode material of the positive electrode, as shown in the practical example 1, preferably, LiFePO₄ is used so that the effect of this design is exerted.

With respect to the positive electrode, based on the comparison between the practical example 5 and the comparative example 1, compared with samples with artificial graphite which is used generally, less smoking were observed in samples with OMAC (registered mark) having natural graphite adhered to amorphous carbon; thus, safety can be enhanced.

Based on the results described above, a lithium ion secondary battery according to the invention in which: resin film has a metal layer and an active material formed on one surface thereof; this is then bent to form an electrode; and the electrode is then laid on one another, was found to exhibit, as for power storage use, satisfactory performance in a repetitive charge/discharge test, and to have excellent performance in safety.

The embodiments and the practical examples disclosed herein are to be considered in all respects as illustrative and not restrictive. The scope of the present invention is set out in the appended claims and not in the description hereinabove, and includes any variations and modifications within the sense and scope equivalent to those of the claims.

1. A secondary battery comprising:
a positive electrode;
a negative electrode; and
a separator,
wherein
at least one of the positive electrode and the negative electrode is formed of: a charge collector having resin as a core, and a metal layer; and an electrode active material on the metal layer,
the metal layer of the charge collector is formed on one surface of the resin, and
the charge collector is folded at least once.

2. The secondary battery according to claim 1,
wherein
as the charge collector having the resin as a core, a plurality of such charge collectors are laid together alternately with the other electrode,
electrode terminals are formed one at an end of each of the charge collectors, and
the electrode terminals are electrically connected in parallel.

3. A secondary battery comprising:
a positive electrode;
a negative electrode; and
a separator,
wherein
at least one of the positive electrode and the negative electrode is formed of: a charge collector having resin as a core, and a metal layer; and an electrode active material on the metal layer,
the charge collector is folded like a folding screen, and
a plurality of electrode terminals are formed at a curved part of the folded charge collector, on one side thereof.

4. The secondary battery according to claim 1,
wherein the metal layer of the charge collector is formed on the resin by vapor deposition.

5. The secondary battery according to claim 2,
wherein the metal layer of the charge collector is formed on the resin by vapor deposition.

6. The secondary battery according to claim 3,
wherein the metal layer of the charge collector is formed on the resin by vapor deposition.

7. The secondary battery according to claim 1,
wherein the secondary battery has a capacity of 4 Ah or more.
